(19) United States
(12) Patent Application Publication
(10) Pub. No.: US 2003/0157266 A1
(43) Pub. Date: Aug. 21, 2003

(54) Metal protection with an electroactive polymer first coat and a second coat applied by an electrostatic coating method

(76) Inventor: Peter Spellane, Ardsley on Hudson, NY (US)

Correspondence Address: Dr. Peter Spellane, Polymer Alloys LLC, P.O. Box 72, Ardsley on Hudson, NY, 10503, US

(21) Appl. No.: 10/360,090

(22) Filed: Feb. 7, 2003

Related U.S. Application Data
(60) Provisional application No. 60/357,064, filed on Feb. 15, 2002.

(51) Int. Cl. B01J 19/08

(52) U.S. Cl. 427/457; 428/500

(57) ABSTRACT

Enhanced corrosion protection of a metal substrate is accomplished in a multi-step process: a first coat comprising an electroactive polymer, such as polyphenylene ether, preferably poly(2,6-dimethyl-1,4-polyphenylene ether), is applied directly to the metal substrate and subsequently a conventional powder coat formulation, such as those comprising epoxy, poly(vinyl chloride), polyamides, polyesters, polyurethanes, acrylics, etc, binders and standard additive materials, is electrostatically applied and cured.

This application claims the benefit of U.S. provisional application No. 60 357 064, filed Feb. 15, 2002.

### 1. FIELD OF THE INVENTION

Steel and aluminum coupons that were first coated with a thin coat, also described as a “wash coat,” of poly(2,6-dimethyl-1,4-phenylene ether) (PPE) were successfully painted with an electrostatically applied powder coat formulation. This invention offers a new method to protect metals from corrosion. The combination of electroactive polymer washcoat with electrostatically-applied powder coat may be usefully employed for the protection of metals in such applications as those in which powder coat alone is used for corrosion protection or appearance. An important example is steel reinforcing bar; “rebar” is embedded in concrete to give the material tensile strength. Rebar manufacturers commonly corrosion-protect their product with fusion-bonded epoxy resin coatings, applied as powder within minutes of fabrication of the steel bar. Other applications include many steel or aluminum “underhood” automotive parts that are protected, in current practice, by powder coat applied directly to uncoated metal. Many fabricated metal objects, including bicycle frames, hand and power tools, metal furniture, refrigerator and dishwasher racks, and other metal objects, that are powder coated for protection or decoration in current practice, may achieve enhanced protection against corrosion by means of the present invention.

### 2. BACKGROUND OF THE INVENTION

Since the mid 1980s there have been literature reports and patent claims that inherently conductive organic polymers, particularly polyaniline (PANI), provide corrosion protection to substrate metals (see D. W. DeBerry, J. Electrochem. Soc. 1985, 132, 1022; B. Wessling, Advanced Mat. 1994, 6, 226). Independent of the conductive polymer reports but contemporaneous with them are reports that polyphenylene ether resin coatings protect metals from corrosion (see M-C. Pham et al. Bull. Societe Chimique France 1985, 6,1169; M. Vijayan et al. Bull. Electrochemistry 1986, 2, 349; T. F. Otero et al. Makromol. Chem. Macromol. Symp. 1987, 8, 255; and S. Pitchumani et al. J. Electrochem. Soc. India 1990, 39, 211). We note that PPE has molecular structure similar to that of PANI. In the polyaniline work, the earliest teachings describe the use of electrically conductive forms of the polymer to protecting metals. The earliest reports concerning metal protection by PPE resins teach that pretreatment of metal surfaces, prior to coating with PPE, is essential for metal protection. U.S. Pat. No. 6,004,628 to Spellane et al. discloses examples of metal protection provided by thin PPE coatings applied from solution to un-pretreated metal, and U.S. Pat. No. 6,376,021 to Spellane teaches the metal protection benefit of heat-treating PPE-coated articles.

In more recent years, more specific teachings speak of the use of conjugated polymers, polyaniline (PANI) in particular, for protection of metals including steel, aluminum, and copper (see U.S. Pat. No. 5,441,772 to McAndrew et al.; U.S. Pat. No. 5,658,649 to Wrobleski et al.; U.S. Pat. No. 5,853,621 to Miller et al.; U.S. Pat. No. 5,928,795 to Spellane et al.; U.S. Pat. No. 6,117,558 to Spellane et al.). An understanding of the electroactivity of the conjugated-type polymers led investigators to propose that oxidation—reduction (redox) chemistry between metal substrate and conjugated polymers is responsible for the observed metal protection. We proposed further that the non-electrically conductive emeraldine base form of PANI, PANI-EB, and the structurally-similar poly(2,6-dimethyl-1,4-phenylene ether) act in similar ways to protect metal. Along with others, we proposed that polyaniline provides inhibitive protection to substrate metal, a protection that is fundamentally different from the barrier protection that non-electroactive resins provide. Standard metal coating resins, such as epoxies and polyurethanes, provide barrier protection but require addition of corrosion inhibitive pigments (CIPs) for active protection against corrosion. Strontium chromate is the most common and effective CIP.

Our earlier work has shown that coatings comprising either the undoped, electrically non-conducting form of polyaniline or polyphenylene ether, which is structurally similar to polyaniline and also electrically non-conducting, applied directly to metals provide excellent protection to metals. We have argued that each of these polymers is capable of electrochemical reaction with substrate metal and that such chemistry leads to metal protection. Separately, it has been generally appreciated that powder coating of metals, as for example with fusion-bonded epoxy resins, enhances the corrosion resistance of the substrate metal. Combining these two methods of metal corrosion should therefore provide even greater protection against corrosion. It is however not obvious that a conventional powder coat technology could be applied to a metal object that has already been primed or wash-coated with an organic resin. A standard method of applying powder paint to a metal article is the electrostatic spray process: the coating powder is dispersed in an air stream and passed through a corona discharge field. Paint particles acquire an electrostatic charge that causes the paint powder to be attracted to and deposited on a grounded article to be coated. Indeed, because electrostatic processes are standard, powder coating is used essentially only for metal substrate. The metallic object is usually powder-coated at room temperature then placed in an oven for a high-temperature bake step that melts the powder allowing formation of a continuous adherent coating. Because paints are usually electrically non-conductive, one does not expect to be able to powder coat an already painted or coated object.

The undoped form of polyaniline and all forms of polyphenylene ether are commonly understood to be electrically non-conductive. In many applications, such as housings for computers, televisions, and other electronic devices, PPE-containing resins are valued for their electrical insulation.

In recent years, the coatings industry has advanced the use of powder-applied coating formulations for the protection and appearance of metal articles. The powder coating process is very attractive: the process is solvent-free and can be highly automated. Especially as the selection of high-quality powder formulations grows, the appearance and performance of powder-coated articles is excellent.

There is a need, however, for improved methods of coating and protecting metal articles.

### 3. SUMMARY OF THE INVENTION

The present invention relates to a coated metal article, methods of preparing a coated metal article, and a method of protecting and decorating a metal article.

In one embodiment, the invention relates to methods of coating a metal substrate consisting essentially of:

coating said metal substrate with a first coat; and

applying a second to said first coat; wherein

said second coat is applied by an electrostatic coating method to said first coat.

In another embodiment, the invention relates to coated metal articles comprising a metal substrate, a first coat and a second coat;

wherein said first coat is applied to said metal substrate; and

said second coat is applied by an electrostatic coating method to said first coat.

In a further embodiment, the invention relates to methods of protecting or decorating a metal substrate consisting essentially of:

coating said metal substrate with a first coat; and

applying a second to said first coat; wherein

said second coat is applied by an electrostatic coating method to said first coat.

The present invention may be more fully understood by reference to the following detailed description and examples, which illustrate non-limiting embodiments of the invention.

### 4. DETAILED DESCRIPTION

### 4.1 Definitions

As used herein, the term “polyphenylene ether resin” refers to a substituted or unsubstituted polyphenylene ether resin.

As used herein, the term “electrostatic coating method” refers to processes for coating metal articles in which a coating material of suitable dielectric constant is polarized by an electric field, causing it to be attracted to a grounded or oppositely charged article to be coated. Electrostatic coating methods may be used in dip coating or spray coating processes. In dip coating processes, an article is coated by being immersed in a liquid coating formulation, then removed, drained, and dried or baked. The immersed metal article is typically grounded or connected to a positive electrode and thereby attracts the negatively charged coating particles of the coating formulation. In spray coating processes, a solvent-containing or solvent-less coating composition is atomized, typically by pressure atomization or air atomization, and applied from the nozzle of a spray gun onto an article to be coated.

As used herein the term “electrostatic spray coating method” refers to processes for coating articles wherein an electrostatic charge, usually negative, is placed on a coating material, either before the material is atomized or as coating particles are formed; a voltage gradient between the source of atomized coating material and a grounded article exerts a force that causes the coating particles to be attracted to the object to be coated. Electrostatic spray coating processes are used for liquid and powder coating formulations. In typical electrostatic spray powder coating processes, a solvent-less coating formulation is entrained in an air stream and delivered through a charged field to a grounded or oppositely charged article, then the object is typically placed in an oven for a baking step that enables the coating formulation to fuse or cure.

As used herein, the phrase “baking step” refers to high temperature step in which the powder-coated article, typically metal and at room temperature, is heated to a temperature that causes the coating particles to melt and form a continuous, adherent coating.

As used herein, the phrases “wash coat” and “first coat” both refer to a thin layer of coating material applied directly to the metal article.

As used herein, the phrase “thermally stable” indicates a material's ability to resist significant decomposition or oxidation when exposed to ambient conditions at a particular temperature.

### 4.2 The Coated Metal Article, and Methods of Preparing and Using Thereof

The present invention relates to a coated metal article, methods of preparing a coated metal article, and a method of protecting and decorating a metal article.

In one embodiment, the invention relates to methods of coating a metal substrate consisting essentially of:

coating said metal substrate with a first coat; and

applying a second to said first coat; wherein

said second coat is applied by an electrostatic coating method to said first coat.

The combination of two different coating steps is expected to provide excellent protection against corrosion because each coating alone protects metal. The two coating steps are complementary in that the electroactive polymer primer coat provides inhibitive protection, and the powder topcoat provides barrier protection. There is further utility in that the powder-applied topcoat may also provide decorative color and texture.

In another embodiment, the invention relates to coated metal articles comprising a metal substrate, a first coat and a second coat;

wherein said first coat is applied to said metal substrate; and

said second coat is applied by an electrostatic coating method to said first coat.

In a further embodiment, the invention relates to methods of protecting or decorating a metal substrate consisting essentially of:

coating said metal substrate with a first coat; and

applying a second to said first coat; wherein

said second coat is applied by an electrostatic coating method to said first coat.

In the present invention, the first coat is applied to a metal substrate. Any type of metal article that would normally be prone to corrosion when exposed to environmental conditions can be used in the practice of the present invention. Metals that a person of ordinary skill in the art may select for practice of the present invention include ferrous metals, carbon steel, stainless steel, aluminum, copper, titanium, and other normally corrodible metals and their alloys. More preferably, the metal substrate is a ferrous metal or an alloy that comprising principally aluminum or titanium.

The first coating comprises a polyaromatic resin. Nonlimiting examples of polyaromatic resins include substituted and unsubstituted polypyrrole, polyaniline, polythiophene, polyphenylene vinylene, polyphenylene sulfide, and poly(arylene ether) resins. In a preferred embodiment, the polyaromatic resin is a polypyrrole, polythiophene, polyaniline, or poly(arylene ether) resin. More preferably, the polyaromatic resin is a poly(arylene ether) resin. Examples of poly(arylene ether) resins are taught in U.S. Patent Application No. 2002/0098366 to Guo, Hua et al. In one embodiment, the poly(arylene ether) resin is a polyphenylene ether resin. Non-limiting examples of polyphenylene ether resins include poly(2,6-dialkyl-1,4-phenylene ether), poly(2,6-dialkoxy-1,4-phenylene ether), and poly(2,6-diphenyl-1,4-phenylene ether). In a most preferred embodiment of the present invention, the polyphenylene ether resin is poly(2,6-dimethyl-1,4-phenylene ether). The preparation, properties, and uses of polyphenylene ether resins and poly(2,6-dimethyl-1,4-phenylene ether) in particular are discussed in the section titled “Poly(phenylene ether)” in the Encyclopedia of Polymer Science and Engineering, Second Edition, John Wiley & Sons, New York, 1988, volume 13, pages 1-30.

The second coating is applied by an electrostatic coating method. Methods of applying electrostatic coatings are known (see Kirk-Othmer: Encyclopedia of Chemical Technology, Fourth Edition, John Wiley & Sons, New York, 1993, volume 6, pages 606-635, pages 635-661, and pages 661-669.)

In one embodiment, the electrostatic coating method is selected from the group consisting of electrostatic dip coating, electrostatic spray coating, and electrostatic spray powder coating. More preferably, the electrostatic coating method is an electrostatic spray powder coating method. When applied as a powder coat, the invention further comprises a baking step. Typically, the bake temperature is approximately 200° C.

When the method comprises a baking step, it is essential that the first coating is thermally stable at the baking temperature. A non-limiting example of such resin is poly(2,6-dimethyl-1,4-phenylene ether), which is thermally stable at 200° C.

This invention also contemplates an embodiment that comprises the steps of coating a metal article with a first coat and applying a second coat to the said first coat, wherein the said second coat is applied by an electrostatic dip coating method.

This invention also contemplates an embodiment that comprises the steps of coating a metal article with a first coat and applying a second coat to the said first coat, wherein the first coat is applied by an electrostatic spray coating or electrostatic spray powder coating method, and the second coat is applied by an electrostatic coating method.

A number of references have been cited, the entire disclosures of which are incorporated herein by reference.

### 5. EXAMPLES

This invention is further illustrated by the following examples, which are nonlimiting embodiments of the present invention.

### 5.1 EXAMPLE 1

A solution of poly(2,6-dimethylphenylene ether) in toluene was prepared in this way: 20 g of Blendex HPP820 (General Electric Specialty Chemicals, Parkersburg, W. Va.) was added to 180 g toluene. With mechanical stirring and heating to slightly over room temperature, the mixture formed a clear and nearly colorless solution.

### 5.2 EXAMPLE 2

Example 5.2 demonstrates the preparation of poly(2,6-dimethylphenylene ether) “wash coats” on steel and aluminum substrate. Cold rolled steel coupons (ACT Laboratories, Hillsdale Mich., 03x06x032, cut only unpolish) were prepared by scrubbing with a ScotchBrite pad, wiping with acetone, and drying with absorbent paper. Aluminum coupons (ACT Laboratories, Al 2024 03x06x025, cut only unpolish) were cleaned by paper-towel wiping with acetone after protective release paper was removed. The 10% solution of PPE in toluene was filtered through a 0.45 micron PTFE filtered and applied to the top 1 cm of each coupon then spread evenly over one side of each coupon with a #24 wire wound rod. The coupons were dried of solvent by baking ca 10-30 minutes at 90° C. in a forced air oven. Smooth, even, colorless, and strongly adhering coatings formed on the metals.

One steel sample was coated with a thinner coating by using the 10% solids solution and a #12 rod; a still thinner coating was prepared with a 5% solids solution (prepared by diluting the 10% solution with toluene) applied with a #12 rod. Coating thicknesses were approximately 5 to 10 microns.

### 5.3 EXAMPLE 3

Example 3 demonstrates the powder coating of poly(2,6-dimethyl-1,4-phenylene ether)-washcoated metal substrate and bare metal substrate.

Powder coating was done with standard powder coating equipment. An epoxy-polyester hybrid, fast cure, paint formulation (RFB 620R8, DuPont Powder Coatings, Houston Tex.) was electrostatically sprayed on poly(2,6-dimethyl-1,4-phenylene ether)-washcoated and un-primed metal samples. The powder paint was cured at approximately 200° C. for 10 minutes.

There was no obvious difference in the powder coatings formed on the poly(2,6-dimethyl-1,4-phenylene ether)-washcoated and the bare (un-coated) metal coupons. The cured powder-coatings showed very good hardness, perfect texture, and very good luster.

It will be understood that the claims are intended to cover all changes and modifications of the preferred embodiments of the invention, herein chosen for the purpose of illustration, which do not constitute a departure from the spirit and scope of the invention.

I claim:

1. A method of coating a metal substrate comprising the steps of:
coating said metal substrate with a first coat; and
applying a second coat to said first coat; wherein
said second coat is applied by an electrostatic coating method to said first coat.

2. The method of claim 1 wherein said electrostatic coating method is selected from the group consisting of electrostatic dip coating, electrostatic spray coating, and electrostatic spray powder coating.

3. The method of claim 1 wherein said first coat comprises polyphenylene ether resin.

4. The method of claim 3 wherein the polyphenylene ether resin is selected from the group consisting of poly(2,6-dialkyl-1,4-phenylene ether)s, poly(2,6-dialkoxy-1,4-phenylene ether)s, and poly(2,6-diaryl-1,4-phenylene ether)s.

5. The method of claim 4 wherein the polyphenylene ether resin is poly(2,6-dimethyl-1,4-phenylene ether).

6. A coated metal article comprising a metal substrate, a first coat and a second coat;
wherein said first coat is applied to said metal substrate; and
said second coat is applied by an electrostatic coating method to said first coat.

7. The coated metal article of claim 6 wherein said second coat comprises an electrostatically applied paint formulation.

8. The coated metal article of claim 7 wherein said second electrostatically applied paint formulation is selected from the group consisting of powder coating formulations and liquid coating formulations.

9. The coated metal article of claim 6 wherein said first coat comprises polyphenylene ether resin.

10. The coated metal article of claim 9 wherein the polyphenylene ether resin is selected from the group consisting of poly(2,6-dialkyl-1,4-phenylene ether)s, poly(2,6-dialkoxy-1,4-phenylene ether)s, and poly(2,6-diaryl-1,4-phenylene ether)s.

11. The coated metal article of claim 10 wherein the polyphenylene ether resin is poly(2,6-dimethyl-1,4-phenylene ether).

12. A method of protecting or decorating a metal substrate comprising:
coating said metal substrate with a first coat; and
applying a second to said first coat; wherein
said second coat is applied by an electrostatic coating method to said first coat.

13. The method of claim 12 wherein said electrostatic coating method is selected from the group consisting of electrostatic dip coating, electrostatic spray coating, and electrostatic spray powder coating.

14. The method of claim 12 wherein said first coat comprises polyphenylene ether resin.

15. The method of claim 14 wherein the polyphenylene ether resin is selected from the group consisting of poly(2,6-dialkyl-1,4-phenylene ether)s, poly(2,6-dialkoxy-1,4-phenylene ether)s, and poly(2,6-diaryl-1,4-phenylene ether)s.

16. The method of claim 15 wherein the polyphenylene ether resin is poly(2,6-dimethyl-1,4-phenylene ether).
